(19) United States
(12) Patent Application Publication
(10) Pub. No.: US 2012/0197688 A1
(43) Pub. Date: Aug. 2, 2012

(54) Systems and Methods for Verifying Ownership of Printed Matter

(76) Inventors: Brent Townshend, Menlo Park, CA (US); Ognjen Todic, Mill Valley, CA (US)

(21) Appl. No.: 13/014,781

(22) Filed: Jan. 27, 2011

(51) Int. Cl. G06Q 30/00; H04N 7/18; H04L 9/32; G06K 9/00

(52) U.S. Cl. 705/14.1; 382/100; 348/61; 726/28

(57) ABSTRACT

The present application discloses systems and methods for verifying ownership of a printed publication. One embodiment includes receiving a first image of a portion of a printed publication from a first communications device associated with a user, the first image including an identifier uniquely associated with the user. The first image may be analyzed to verify the printed publication and to confirm that identifier is associated with the user. Some embodiments also include authenticating digital content associated with the identified publication for viewing on and/or downloading to one or more communications devices associated with the user whose associated identifier appears in the first image.

### BACKGROUND

People have purchased and read books, magazines, newspapers, journals, and other printed publications for many years. Many people may also keep copies of their purchased publications in a personal library for reference at a later date.

One problem with individual printed publications is that they may be difficult and/or cumbersome for people to transport and/or store. Transporting multiple publications may even be more difficult and/or cumbersome. Similarly, one problem with personal libraries is that they may consume a lot of space in a person's home or office. Printed publications in electronic formats have clear advantages over physical printed publications in ease of use, transportation, and storage.

Many publishers have begun to make publications available in electronic formats. Some publications may be available for download to electronic devices with communications interfaces. Some publications may also be viewable by electronic devices by accessing websites and/or other network-based server systems that may host electronic versions of the publications.

But while newer publications may be available in electronic formats, some older publications may not currently be available in electronic form. Similarly, even for some newer publications, an electronic version of the publication may not be available until some time after the printed publication goes on sale. Over time, however, most previously published publications are expected to be available in an electronic form for viewing on and/or downloading to electronic devices for reading.

### SUMMARY

The present application discloses systems, articles of manufacture including computer readable media, and methods for verifying ownership of printed matter. In addition, systems, articles of manufacture, and methods are described herein for authenticating digital content associated with printed matter. Authenticated digital content may be made available for viewing on and/or downloading to communications devices associated with the owner of the printed matter.

Some embodiments may include systems, articles of manufacture including computer readable media, or methods for receiving an image of a portion of a printed publication from a communications device associated with a user. The image may include an identifier uniquely associated with the user. After receiving the image, the image may be analyzed to verify the printed publication and to confirm that the identifier is associated with the user. In some embodiments, verifying the printed publication may include either (i) identifying the printed publication based on the first image or (ii) confirming that a user-supplied identification of the printed publication is accurate based on the first image.

In some embodiments, digital content associated with the verified printed publication may be authorized for viewing on and/or downloading to the communications device after confirming that the identifier is associated with the user. In some embodiments, the digital content may be authorized for viewing on and/or downloading to additional communications devices (instead of, or in addition to) the communications device that sent the image. Some embodiments may also include storing a record of the authorization in a database system configured to be accessible for future confirmation of the authorization.

The systems and methods described herein are not limited to use with any particular type of printed publication. For example, the printed publication may be a book, magazine, newspaper, or other printed publication, and the image may be, for example, a digital photograph, photocopy, or scan, that includes a portion of the printed publication. In some embodiments, the image may correspond to a particular predefined portion of the printed publication.

The digital content associated with the printed publication may be, for example, an electronic copy of the printed publication (or a portion thereof) and/or multimedia content associated with the identified printed publication. In some embodiments, an offer for a discounted product or service associated with the identified printed publication may also be generated in response to confirming that the user owns the printed publication.

The identifier associated with the user may be, for example, one or more alpha-numeric letters and/or images. In some embodiments, the identifier may be applied with a stamp. The stamp may include alpha-numeric letters, images, a signature, and/or an identification number. In some embodiments, the identifier may be applied to the portion of the printed publication in a manner so that the identifier partially overlies at least a portion of text, graphics, or other symbols included within the portion of the printed publication.

In some embodiments, a second image corresponding to another portion of the printed publication may be requested at some time after the initial verification. The second image may also include the identifier associated with the user. After receiving the second image in response to the request, the second image may be analyzed to verify the printed publication and to confirm that the second image includes the identifier associated with the user. Some embodiments may additionally include storing the received images in a database, and associating the images with the printed publication.

Still other embodiments may include systems, articles of manufacture including computer readable media, or methods for acquiring a first image of a portion of a printed publication. The first image may include an identifier uniquely associated with a user. After acquiring the image, the image may be sent to a server system configured to verify the printed publication and to confirm that the identifier is associated with the user.

In some embodiments, a message may be received from the server system in response to sending the image. The message from the server system may include an indication that the server system has authorized digital content associated with the verified printed publication for viewing on and/or downloading to the communications device. The indication may include a key, a password, a link, a token, or any other data that may be used for viewing and/or downloading the digital content to the communications device. In some embodiments, the key, password, link, token, or other data may be used to view and/or download the digital content to other communications devices (instead of, or in addition to) the communications device that sent the image. In some embodiments, the communications device may use the key, password, link, token, or other data in connection with sending a request for the digital content to a content server, and the requesting communications device may receive the digital content from the content server. In some embodiments, the communications device may additionally or alternatively receive an offer for at least one discounted product or service associated with the printed publication.

In some embodiments, the communications device may receive a request from the server system for a second image corresponding to at least one additional portion of the printed publication. The second image may also include the identifier. After receiving the request, the communications device may acquire the second image, and then send the second image with the identifier to the server system.

Further embodiments may include receiving a physical copy of a printed publication, and verifying that the physical copy of the printed publication is a valid copy (i.e., not an unauthorized reproduction) of the printed publication. In response to verifying that the physical copy is a valid copy of the printed publication, some embodiments may include (i) initiating the authorization of digital content associated with the printed publication for viewing on and/or downloading to one or more communications devices associated with a user, and/or (ii) initiating the generation of a coupon for at least one discounted product or service associated with the verified printed publication. In some embodiments, the physical copy of the printed publication may include an identifier associated with a user. Other embodiments may include receiving login credentials associated with a user, applying an identifier associated with the user to at least a portion of the printed publication, and/or generating an image of a least a portion of the copy of the printed publication.

### BRIEF DESCRIPTION OF THE DRAWINGS

FIG. 1A shows an overview of an example system including a user's communications device configured to send an image of a printed publication having been stamped with a identifier to a server system configured to analyze the image, verify the printed publication, and confirm that the identifier is associated with the user.

FIG. 1B shows an example of a computing device that may correspond to the servers, communications devices, and other computing devices according to some embodiments described herein.

FIGS. 2A-2F show example methods that may be performed by a server system according to some embodiments of the disclosed systems and methods.

FIGS. 3A-3C show example methods that may be performed by a client communications device according to some embodiments of the disclosed systems and methods.

FIGS. 4A-4B show other example methods that may be performed by humans, computer-based kiosks (or similar devices), and/or combinations thereof according to some embodiments of the disclosed systems and methods.

### DETAILED DESCRIPTION

The following detailed description describes various features and functions of the disclosed systems and methods with reference to the accompanying figures. In the figures, similar symbols typically identify similar components, unless context dictates otherwise. The illustrative system and method embodiments described herein are not meant to be limiting. Certain aspects of the disclosed systems and methods can be arranged and combined in a wide variety of different configurations, all of which are contemplated herein.

1. Overview

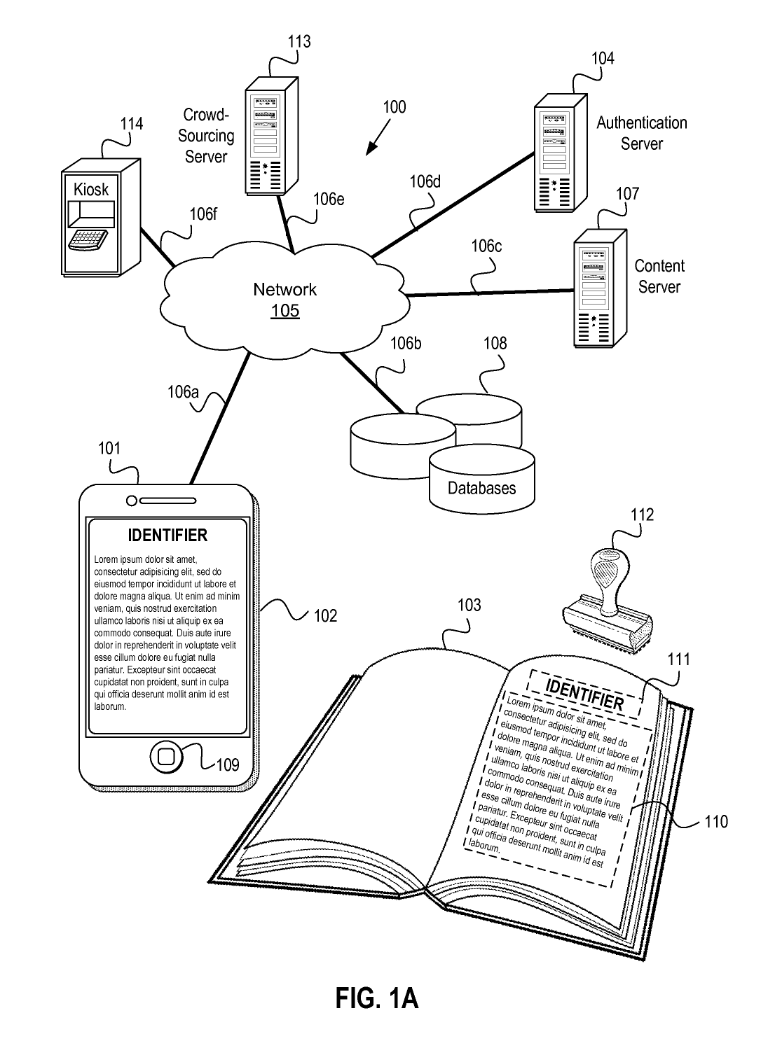

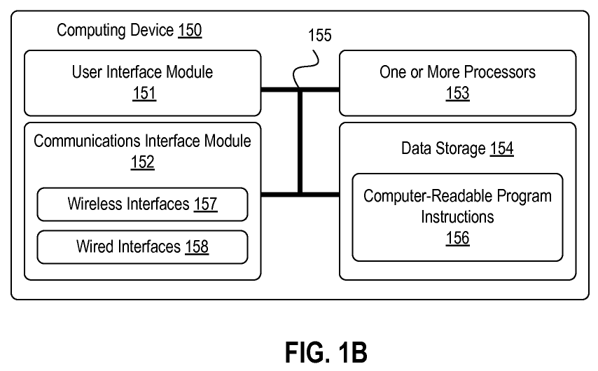

FIG. 1A shows an example of a system 100 where a user's communications device 101 may be configured to acquire and send an image 102 of a portion 110 of a printed publication 103 to an authentication server 104 via a network 105. The image 102 may include an identifier 111 associated with the user. The printed publication 103 may be a book, magazine, journal, newspaper, or any other type of printed publication. In FIG. 1A, the portion 110 of the printed publication 103 and the identifier 111 are shown enclosed with a dotted line for illustration and explanatory purposes. In operation, the dotted lines enclosing the portion 110 of the printed publication 103 and the identifier 111 typically would not appear on the actual page of the printed publication 103.

The user's communication device 101 may be any of a cellular telephone, a smart phone, a personal digital assistant (PDA), tablet computer, laptop computer, desktop computer, or any other similar communications device with one or more processors and a communications interface. The user's communications device 101 may be equipped with an integrated digital camera (not shown) that may be configured to acquire the image 102 of the printed publication 103. In some embodiments, the user's communications device 101 may be configured to acquire the image 102 via the integrated digital camera (not shown) in response to receiving an input via a user input controller 109. In some embodiments, the user's communications device 101 may alternatively receive the image 102 from a separate digital camera (not shown) or some other source that has acquired a digital copy of the image 102. The user's communications device 101 may also be configured to send the image 102 to the authentication server 104 so that the authentication server 104 can analyze the image 102 to identify the printed publication 103 and to verify that the identifier 111 in the image 102 is associated with the user.

In some embodiments, a communications device may be associated with a user if the user is a registered owner and/or user of the communications device. For example, mobile telephones, personal media players, and personal computers may typically have users associated with them. Additionally, in some embodiments, a user may use a particular communications device (e.g., a mobile phone, personal media player, and/or personal computer) to log in to a website associated with the authentication server 104 to establish some sort of association between the user and the communications device. The communications device 101 may be associated with a user in other ways as well.

The identifier 111 may be associated with a particular user such that no two users have the same identifier. The identifier 111 associated with the user may include one or more alpha-numeric letters, shapes, forms, and/or images. In some embodiments, the identifier 111 may include or otherwise take the form of a stamp, a signature, or an identification number. The identifier may be applied to some portion of the publication 103 by a user after the user has purchased the publication 103. In some embodiments, the identifier may be applied to a page (or cover, spine, etc.) of the printed publication 103 via a stamping device 112. In other embodiments, the identifier may be applied to the printed publication 103 in other ways, such as, for example, a sticker or decal, a pen or marker, or some other means for marking, imprinting, or affixing the identifier 111 on or to the portion 110 of the printed publication 103 shown in the image 102.

In some embodiments, requiring a user to apply or affix the identifier 111 to some portion of the printed publication 103 may deter users from applying, imprinting and/or affixing their identifier 111 to printed publications that they do not own in part because the identifier is associated with the user, and thus, the identifier can be traced back to the user. As a result, a user may be less likely to apply their personal identifier to printed publications that they do not actually own, such as printed publications they may have found in a public library, bookstore, or from some other location.

The identifier 111 in FIG. 1A is shown as having been applied to the top of a page of text in the printed publication 103. However, the identifier 111 could be placed in other locations. For example, in some embodiments, at least a portion of the identifier 111 may partially overlie a portion of the text, graphics, or other symbols included in the portion 110 of the printed publication 103. In some embodiments, the identifier 111 may be some form of closed shape around the publication's bar code or International Standard Book Number (ISBN), where the closed shape of the identifier 111 may have one or more markings that overly the publication's bar code or ISBN so that re-stamping or re-imprinting a new identifier over the bar code or ISBN is difficult or impractical.

In this manner, the placement of the identifier may also contribute to preventing fraud. Specifically, such an arrangement may make it more difficult for users to cover a previously-applied identifier and replace it with their own identifier in part because (i) covering a previously-applied identifier may also cover a portion of the text, graphics, or other symbols, and (ii) it may be more difficult to reproduce the portion of the printed publication that had been previously covered with an identifier.

In FIG. 1A, the portion 110 of the printed publication 103 shown in the image 102 is a full page of text from the printed publication 103. However, the portion 110 of the printed publication could be less than a full page of text. For example, in some embodiments, the portion appearing in a particular image may be any portion of the printed publication 103, such as a subset of the text and/or figures appearing on a page of the printed publication 103, the front or back cover of the printed publication 103 or a portion thereof, or the spine of the printed publication 103 or a portion thereof. In some embodiments, in order to verify the user's ownership of the printed publication 103, the portion of the printed publication 103 appearing in the image 102 may be required to be a specific and pre-defined portion of the printed publication 103. In such embodiments, the authentication server 104 may be configured to identify the printed publication 103 and verify the user's ownership of the printed publication 103 (based on the presence of the user's identifier) only when the image 102 contains the specific predefined portion of the printed publication 103. However, other embodiments may not be so limited.

After acquiring the image 102, the user's communications device 101 may send the image 102 to the authentication server 104 via network 105. The network 105 may include a plurality of interconnected networks, including one or more wireless networks, the public Internet, wide area networks, and/or local area networks. The network 105 shown in FIG. 1A includes a plurality of communications links 106a-f. The communications links 106a-f may correspond to any combination of wireless and/or wired communications links configured to provide communications between any or all of the user's communications device 101, the authentication server 104, a content server 107, a crowd-sourcing server 113, a kiosk 114, and/or one or more databases 108.

The authentication server 104 may be configured to receive and analyze the image 102 to verify the printed publication 103 appearing in the image 102 and to confirm that the identifier 111 shown in the image 102 is associated with the user. In some embodiments, verifying the printed publication may include either (i) identifying the printed publication based on the first image or (ii) confirming that an identification of the printed publication supplied by a user is accurate based on the first image.

The authentication server 104 may be configured to verify the printed publication 103 by analyzing the text and/or figures in the portion 110 of the printed publication 103 that appear in the image 102. In some embodiments, verifying the printed publication 103 may include searching for the text and/or figures in the portion 110 of the printed publication 103 in one or more databases 108. The authentication server 104 may be configured to access one or more databases 108 via network 105. As described previously, in some embodiments, the authentication server 104 may be configured to verify a particular printed publication only when the image 102 contains a specific, pre-defined portion of the printed publication 103. However, in other embodiments, the authentication server 104 may be configured to verify the printed publication 103 by analyzing any portion of the printed publication 103—not just a specific, pre-defined portion of the printed publication 103.

The authentication server 104 may also be configured to determine a user associated with the identifier 111 appearing in the image 102. In some embodiments, the authentication server 104 may be configured to determine whether the identifier 111 appearing in the image 102 is associated with the user that sent the image 102. In some embodiments, determining whether the user associated with the identifier 111 may include searching for the identifier 111 in the one or more databases 108. In operation, the authentication server 104 may be able to determine that a particular user associated with the identifier 111 owns a copy of the printed publication 103 shown in the image 102 at least in part because the image 102 includes the identifier 111 associated with the user. In this manner, confirming that the identifier 111 associated with the user appears in the image 102 of the printed publication 103 may be used as a proxy for verifying that the user owns the printed publication 103.

In some embodiments, the authentication server 104 may also be configured to authorize digital content (not shown) associated with the identified printed publication 103 for viewing on and/or downloading to the user's communications device 101 (or any other communications device associated with the user) in response to confirming that the identifier 111 shown in the image 102 is associated with the user. The digital content may include an electronic copy of the printed publication 103. The digital content may additionally or alternatively include multimedia content associated with the printed publication 103. For example, if the printed publication 103 is a book, the multimedia content associated with the printed publication 103 may include an electronic copy of a movie or television show or series associated with the book. Similarly, if the printed publication 103 is a magazine or journal, the multimedia content may include interactive charts or graphs associated with articles in the magazine or additional information (website links, product brochures, etc.) based on advertisements appearing in the printed publication 103.

In some embodiments, one or more offers for discounted products or services associated with the printed publication 103 may be sent to the user via email, text message, or any other form of electronic communication. For example, instead of (or in addition to) authorizing digital content for viewing on and/or downloading to a user's communications device, the authentication server 104 (or some other server) may instead (or additionally) send the user a coupon for discounted products or services associated with the printed publication 103. Products or services associated with the printed publication 103 may include, for example, admissions to theme parks associated with the printed publication 103, museum admissions for museums associated with the printed publication 103, admissions for a movie or live theater show associated with the printed publication 103, merchandise or other products associated with the printed publication, or any other product or service associated with the printed publication 103. In some embodiments, the coupon for the discounted product or service may be associated with advertisers appearing in the printed publication 103.

The authentication server 104 may also be configured to store a record that the authentication server 104 has authorized some particular digital content associated with the printed publication 103 for viewing on and/or download to the user's communications device 101 (or any other communications device associated with the user). In some embodiments, the authentication server 104 may be configured to store a record of the authentication in the one or more databases 108, where at least one of the databases 108 may be accessible for future confirmation of the previous authorization.

By storing a record of the authorization in an accessible database, third parties may be able to access the database to verify or confirm that particular digital content has been authorized for viewing on and/or downloading to a communications device associated with the user. In this manner, a particular user may have an authorized list or authorized library of digital content that the user is authorized to view on or download to one or more (or any) of the user's communications devices. For example, a publication seller (e.g., publisher, a seller, a reseller, a retailer, or any other company or organization that may sell printed publications) may wish to offer a user an electronic copy of a particular book at a discounted price (or perhaps for free) based on the user having purchased a physical copy of the book. If the authentication server 104 has stored a record of the authentication in a database, such as one of the databases 108, that is accessible by the publication seller, then the publication seller may access the database 108 to confirm that the authentication server 104 has verified a user's ownership of the particular book via the procedures described herein.

In some embodiments, the authentication server 104 may also be configured to re-verify a user's ownership of a particular printed publication 103 after some period of time has elapsed. Re-verifying ownership may be advantageous in situations where a user purchases a printed publication, obtains an electronic copy of the printed publication, and then sells the printed publication later to retain only the electronic copy. The period of time may be configurable to be some number of days, weeks, months, years, etc. In some embodiments, different publication sellers may have different timeframes for requiring re-verification of ownership. Additionally, the authentication server 104 may in some embodiments be configured to periodically re-verify ownership of the printed publication on a regular or semi-regular basis.

In operation, the authentication server 104 may be configured to re-verify a user's ownership of a printed publication by requesting a new image of another portion of the printed publication with the user's identifier 111 applied thereto. In response to receiving the request from the authentication server 104, the user can then use the communications device 101 to acquire the new image that includes (i) the requested portion of the printed publication and (ii) the user's identifier 111. The new image can then be sent to the authentication server 104 in response to the authentication server's request, and the authentication server 104 can analyze the new image to verify the printed publication and to confirm that the new image includes the user's identifier 111. Analyzing the new image for the re-verification procedure may be substantially the same as analyzing the original image 102 in the initial verification procedure.

In some embodiments, the authentication server 104 may de-authorize digital content for viewing on and/or downloading to the user's communications device 101 (or any other communications device associated with the user) if the authentication server 104 does not receive the requested new image for analysis within a specified timeframe. The specified timeframe may be configurable and/or specified by a particular publication seller. For example, in some embodiments, the timeframe may be a few hours, a few days, a few weeks, a few months, or some other timeframe. Thus, the specified timeframe may vary between different printed publications.

Similar to the manner in which the authentication server 104 may be configured to store an authorization record in the one or more databases 108, the authentication server 104 may also in some embodiments be configured to store a record of the de-authorization of digital content for viewing on and/or downloading to a user's communications devices. By storing a record of the de-authorization in an accessible database, third parties may be able to access the database to verify or confirm that particular digital content is authorized (or de-authorized) for viewing on and/or downloading to a communications device associated with the user.

After identifying the printed publication 103 and verifying that the identifier 111 appearing in the image 102 is associated with a user, the authentication server 104 may also be, in some embodiments, configured to send an indication to the user's communications device 101 to advise the user that digital content associated with the printed publication 103 has been authorized for viewing on and/or downloading to a communications device associated with the user. The indication may include a key, a token, a password, a link, or other similar mechanism for use in viewing and/or downloading digital content to a communications device associated with the user.

For example, the indication may include an electronic key or token that, when stored on a device such as communications device 101, may enable the digital content to be viewed on or downloaded to the communications device 101. Similarly, the indication may in some embodiments include an Internet link for accessing the digital content. Alternatively, the indication may include an Internet link for downloading an electronic key or token that can be used for accessing the digital content. Also, the indication may in some embodiments include a password for use in accessing (e.g., viewing and/or downloading) the digital content from a communications device associated with the user. In some embodiments, the indication may simply be a message advising the user that the digital content has been authorized for viewing on and/or downloading to any communications device associated with the user.

However, some embodiments may not include a specific indication. Instead, the digital content may be added to a list of content that is authorized for viewing on and/or downloading to the user's communications device 101 or any other of the user's communications devices. In these embodiments, instead of receiving an authorization indication, the user can determine whether particular content was successfully authorized for viewing and/or downloading by viewing a list of authorized content to determine whether the particular content appears in the list of authorized content.

After digital content has been authorized for viewing on and/or downloading to a user's communications devices, a user may use communications device 101 (or another communications device) to send a request to view and/or download authorized content. The authorized digital content may be viewed on and/or downloaded to communications device 101 or some other communications device associated with the user. A communications device from which the user sends the request to view and/or download the digital content may be different than the communications device 101 that the user may have sent the image 102 from earlier. For example, a user may have initially sent image 102 from the communications device 101, but the user may later request to view and/or download the authorized content to a desktop or laptop computer, television, media player, or other communications device.

In some embodiments, the communications device that the user ultimately uses to view and/or download the authorized content may be different from both (i) the communications device 101 from which the user initially sent the image 102, and (ii) the communications device from which the user sent the request to view and/or download authorized content. For example, a user may have used communications device 101 to send image 102 to authentication server 104, the user may have used a laptop computer to send a request to view and/or download authorized content, and the user may actually download the authorized content to a television, media player, or e-book reader for viewing, for an example.

In some embodiments, the request to access authorized content may be sent to the authentication server 104. In response to receiving the request, the authentication server may check to determine whether the requested content has previously been authorized for viewing on and/or downloading to communications devices associated with the user that initiated the request. In some embodiments, checking to determine whether the requested content has previously been authorized may include accessing the one or more databases 108 to determine whether the requested content has been previously authorized for viewing on and/or downloading to communications devices associated with the user. In some embodiments, records of previous authorizations may be stored in one of the databases 108.

In other embodiments, the request may be sent to a content server 107. In response to receiving the request, the content server 107 may be configured to query the one or more databases 108 to determine whether the requested content has been previously authorized for viewing on and/or downloading to communications devices associated with the user that initiated the request. In some embodiments, the content server 107 may be operated by a different company or organization than the authentication server 104. In other embodiments, the content server 107 and the authentication server may be operated by the same company or organization.

After the authentication server 104 (or the content server 107, depending on the embodiment) has verified that the requested content has been previously authorized for viewing on and/or downloading to communications devices associated with the user that initiated the request, the requested digital content can then be transmitted to a communications device associated with the requesting user, such as, for example, communications device 101.

In some embodiments, a request may be sent to a user's communications device 101 with instructions to send another portion of the printed publication 103 to a requesting server. After receiving the requested image, the requesting server may be configured to store the image 102 in a database, such as one of the one or more databases 108, and associate the received image with the printed publication 103. This periodic requesting of additional images may be part of either (i) the re-verification procedure described above or (ii) a separate procedure designed to build a database of images of printed publications 103 from users. In some embodiments, the crowd-sourcing server 113 may be configured to periodically request additional images for storage and association with the printed publication 103. In other embodiments, the authentication server 104 may be configured to periodically request the additional images for storage and association with the printed publication 103. In some embodiments, the crowd-sourcing server 113 may be configured to create entire digital copies of particular printed publications by periodically requesting images for storage and association with the printed publication from many different users.

The crowd-sourcing functionality described herein may be useful, for example, in situations where the authentication server 104 is unable to identify a publication 103 based on the portion 110 of the publication 103 that may appear in the image 102 received from the communications device 101. If the authentication server 104 is not able to identify the publication 103 from the image 102, then the authentication server 104 may send a request to the communications device 101 to send an image containing the bar code or ISBN of the publication 103. In some embodiments, the authentication server 104 may communicate with the crowd-sourcing server 113 to offload the crowd-sourcing functions to crowd-sourcing server 113 so that the authentication server 104 can focus on authentications. In other embodiments, the authentication server 104 and the crowd-sourcing server 113 may cooperate in the crowd-sourcing function.

Either way, the authentication server 104 and/or the crowd-sourcing server 113 may be configured to look up the bar code or ISBN contained in the requested image in one of a number of publicly accessible databases to obtain the title and other bibliographic information related to the publication 103. The title and bibliographic information related to the publication 103 can then be associated with the images received from the communications device 101. Once the crowd-sourcing server 113 has the title and other bibliographic information associated with a particular publication, the crowd-sourcing server 113 may be able to create a digital copy of that printed publication by periodically requesting images for storage and association with the printed publication from the initial user and any subsequent users who may later send images of the publication for verification. By periodically requesting an additional page from a few hundred users, the crowd-sourcing server 113 may be able to create a digital copy of the printed publication in a fairly short period of time.

FIG. 1A illustrates embodiments where the authentication server 104, the content server 107, and the crowd-sourcing server 113 are separate server devices connected via the network 105. However, in other embodiments, the functionality of any or all of the three described servers may be implemented at a single server or distributed across multiple servers beyond the three server systems shown in FIG. 1A.

Additionally, some embodiments may rely on a greater amount of human interaction to perform the verification and confirmation procedures described herein. For example, in some embodiments, a person may stamp, mark, or otherwise affix his or her identifier to a printed publication, and then present a physical copy of the printed publication with the identifier to a human to perform the verification and authentication procedures. The human may be an employee or other worker, manager, attendant, shop owner, etc. working at a bookstore, library, retail outlet, or other establishment. The human may verify that the copy of the printed publication presented by the person is a valid copy of the printed publication. Verifying that the copy of the printed publication is a valid copy may include physically inspecting the printed publication to verify that the presented copy is not a photocopy, pirated copy, or other form of unauthorized reproduction of the printed publication.

In addition to verifying that the presented copy of the printed publication is a valid copy of the printed publication, the human may also initiate a lookup in a database of identifiers to determine a user associated with the identifier shown on the printed publication. In some embodiments, the user whose identifier appears on the printed publication may be the person who presented the printed publication for verification. In other embodiments, the user whose identifier appears on the printed publication may be different than the person who presented the printed publication for verification.

Initiating the lookup in the database of identifiers may include any of: (i) sending an authorization request message to the authorization server 104; (ii) sending an authorization request message to another server (not shown); (iii) accessing an interactive voice response system via a telephone; (iv) sending an image of a portion of the printed publication that includes the identifier to the authentication server 104 so that the authentication server 104 may perform the verification and confirmation functions described elsewhere herein; or (v) otherwise causing an electronic system to access a database of identifiers for the purpose of confirming that the identifier shown on the printed publication is associated with the person who presented the printed publication.

In some embodiments, the human may also authorize (or at least initiate the authorization of) digital content associated with the printed publication for viewing on and/or downloading to one or more communications devices associated with the user whose identifier appears in the printed publication. In some embodiments, the human may authorize the digital content via the authentication server 104. For example, the human may authorize the digital content by responding to a prompt or query from the authentication server 104 in connection with the confirmation procedure. In other embodiments, the human may authorize the digital content by sending an authentication message to the authentication server 104 or some other online directory that maintains a list or library of the user's authorized content.

In some embodiments, the human may additionally or alternatively present the person with a coupon for one or more discounted products and/or services associated with the printed publication. The coupon may be similar to the coupons described elsewhere herein. For example, the coupon may be in a hard copy form, an electronic form (e.g., an email, text message, etc.), coupon code form (e.g., an alphanumeric string to enter into a computing system at the point of sale), or other similar form or format.

Other embodiments may include a kiosk-based computing system 114 or a similar device to complement or replace the actions of the human. For example, a kiosk 114 or similar device located in a bookstore, library, retail outlet, shopping mall, or other similar type of establishment may be configured to receive a copy of a printed publication 103. The kiosk 114 (or perhaps a human associated with operating the kiosk) may verify that the copy of the printed publication 103 is a valid copy (i.e. not an unauthorized reproduction) of the printed publication. The kiosk 114 may determine whether the publication 103 is valid by using an imaging system configured to distinguish between bound books and photocopies, for example. Similarly, to deter the use of more sophisticated counterfeits, the kiosk may be equipped with cameras (similar to an Automated Teller Machine) to document kiosk users.

In some embodiments, the identifier 111 corresponding to a user may have already been applied to the printed publication 103 before receipt by the kiosk 114. In these embodiments, the kiosk 114 may be configured to determine the user whose identifier 111 appears on the copy of the printed publication 103. After determining the user, the kiosk 114 may be configured to authorize (or at least initiate the authorization of) digital content associated with the printed publication 103 for viewing on and/or downloading to one or more communications devices associated with the determined user, such as communications device 101. The authorization procedures performed by the kiosk 114 may be similar to the authorization procedures described elsewhere herein. The kiosk 114 may additionally or alternatively be configured to generate (or at least initiate the generation of) at least one coupon for at least one discounted product or service associated with the printed publication 103 for delivery to the determined user. The coupon and the coupon generation procedures performed by the kiosk 114 may be similar to the coupons and coupon generation procedures described elsewhere herein.

In still other embodiments, an identifier 111 corresponding to a user may not have already been applied to the printed publication 103 before receipt of the publication by the kiosk 114. In these embodiments, a user may provide the kiosk 114 with account credentials such as, for example, typing a username and password into a user interface, swiping a card in a magnetic card reader, presenting an radio frequency identifier (RFID) tag to an RFID sensor, presenting a bar code or other similar image to an optical reader, or other similar ways for providing account credentials. After the user has provided the account credentials to the kiosk 114, the kiosk 114 may, in some embodiments, be configured to apply the identifier 111 associated with the user to the copy of the printed publication 103. Then, and similar to the manner described elsewhere herein, the kiosk 114 may be configured to (i) authorize (or at least initiate the authorization of) digital content associated with the printed publication 103 for viewing on and/or downloading to one or more communications devices associated with the determined user and/or (ii) generate (or at least initiate the generation of) at least one coupon for at least one discounted product or service associated with the printed publication 103 for delivery to the determined user.

2. Computing Device Architecture

FIG. 1B is a block diagram of an example of a computing device 150 that may correspond to the communications device 101, the authentication server 104, the content server 107, the crowd-sourcing server 113, and/or the kiosk 114 shown in FIG. 1A. In the embodiments shown in FIG. 1A, the authentication server 104, the content server 107, and the crowd-sourcing server 113 may be individual and separate computing devices. In other embodiments, the functionality of the three server systems may be performed by a single computing device. In still other embodiments, the functionality of one or more of the three server systems may be distributed across multiple computing devices. The communications device 101, the authentication server 104, the content server 107, the crowd-sourcing server 113, and/or the kiosk 114 may include some of the same functional components, but the size, capacity, and performance of the components may vary in each system depending on their respective intended applications.

The computing device 150 may include a user interface module 151, a network-communication interface module 152, one or more processors 153, and data storage 154, all of which may be linked together via a system bus, network, or other connection mechanism 155.

The user interface module 151 may be operable to send data to and/or receive data from external user input/output devices. For example, the user interface module 151 may be configured to send/receive data to/from user input devices such as a keyboard, a keypad, a touch screen, a computer mouse, a track ball, a joystick, and/or other similar devices, now known or later developed. The user interface module 151 may also be configured to provide output to user display devices, such as one or more cathode ray tubes (CRT), liquid crystal displays (LCD), light emitting diodes (LEDs), displays using digital light processing (DLP) technology, printers, and/or other similar devices, now known or later developed. The user interface module 151 may also be configured to generate audible output(s), such as a speaker, speaker jack, audio output port, audio output device, earphones, and/or other similar devices, now known or later developed.

The network-communications interface module 152 may include one or more wireless interfaces 157 and/or wired interfaces 158 that are configurable to communicate via a network, such as the network 105 shown in FIG. 1A. The wireless interfaces 157 may include one or more wireless transceivers, such as a Bluetooth transceiver, a Wi-Fi transceiver, a WiMAX transceiver, a CDMA transceiver, a 3G/4G transceiver, and/or other similar type of wireless transceiver configurable to communicate via a wireless network. The wired interfaces 158 may include one or more wireline transceivers, such as an Ethernet transceiver, a Universal Serial Bus (USB) transceiver, or similar transceiver configurable to communicate via a twisted pair wire, a coaxial cable, a fiber-optic link or a similar physical connection to a wireline network.

In some embodiments, the network communications interface module 152 may be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms may be used as well or in addition to those listed herein to secure (and then decrypt/decode) communications.

The one or more processors 153 may include one or more general purpose processors (e.g., microprocessors manufactured by Intel and/or Advanced Micro Devices) and/or one or more special purpose processors (e.g., digital signal processors, application specific integrated circuits, etc.). The one or more processors 153 may be configured to execute computer-readable program instructions 156 that may be contained in the data storage 154 and/or other instructions as described herein.

The data storage 154 may include one or more computer-readable storage media that can be read from, written to, or otherwise accessed by at least one of the processors 153. The computer-readable storage media may include encoded instructions. The instructions may include computer-readable program instructions 156, including instructions that may be used by the one or more processors 153 to perform the functions and methods described herein.

The one or more computer-readable storage media 156 may include volatile and/or non-volatile storage components, such as optical, magnetic, organic or other memory or disc storage, which may be integrated in whole or in part with at least one of the processors 153. In some embodiments, the data storage 154 may be implemented using a single physical device (e.g., one optical, magnetic, organic or other memory or disc storage unit), while in other embodiments, the data storage 154 may be implemented using two or more physical devices. The data storage 154 may be physically integrated with the computing device 150. But in some embodiments, the data storage 154 may also include data storage that is external to the computing device 150. For example, in some embodiments, the data storage media may also include one or more external volumes of data, such as the one or more databases 108 shown in FIG. 1A.

3. Methods for Implementation with Server Systems

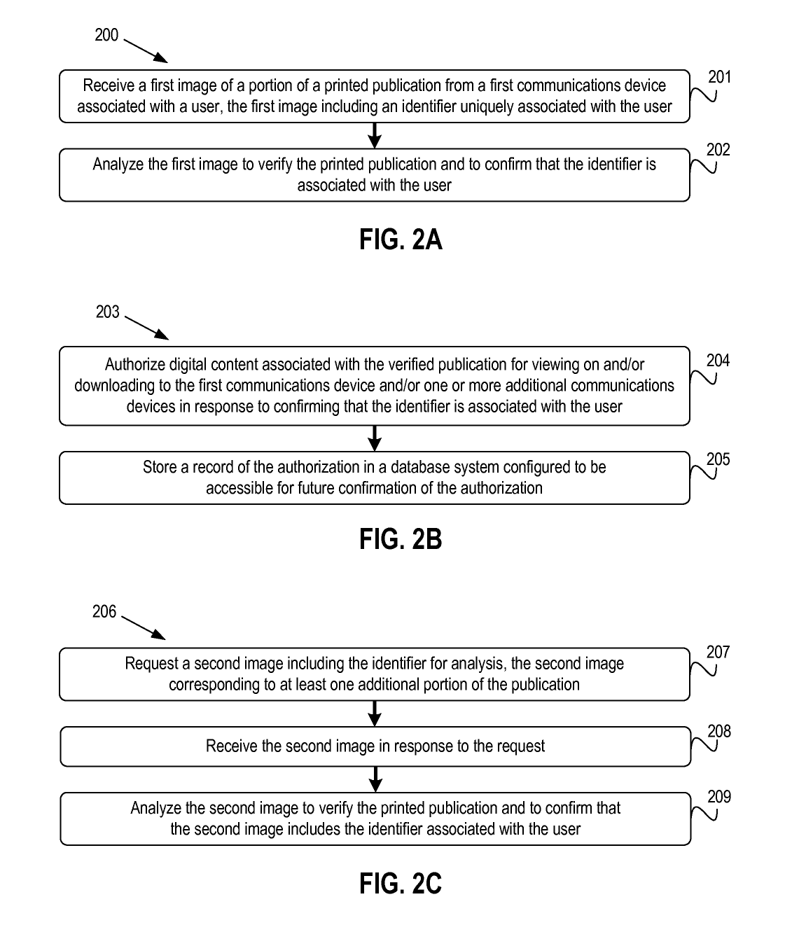

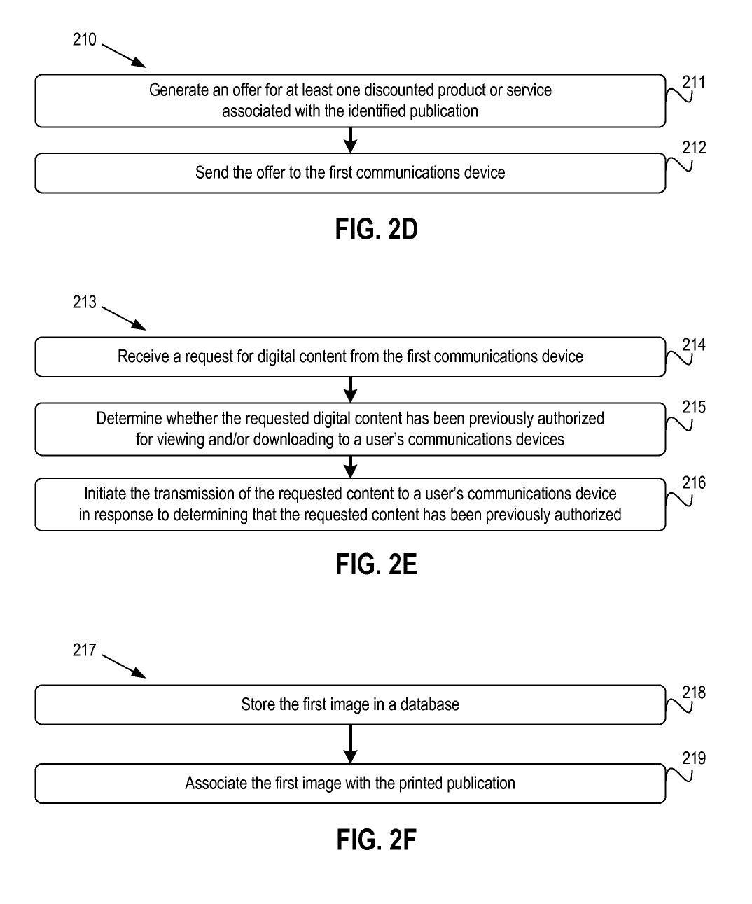

FIGS. 2A-2F show example methods that may be performed by a server configured to analyze an image of a printed publication to verify the printed publication and to confirm that the identifier is associated with the user according to some embodiments. In some embodiments, one or more features and/or functions of the methods shown and described with respect to FIGS. 2A-F may be executed and/or performed by one or more servers, such as, for example, the authentication server 104, the content server 107, and/or the crowd-sourcing server 113 shown and described with respect to FIGS. 1A and 1B. However, some features and/or functions of the methods shown and described with respect to FIGS. 2A-F may be executed and/or performed by servers different than the server systems shown and described with respect to FIGS. 1A and 1B.

FIG. 2A shows an example method 200 for verifying a user's ownership of a printed publication, such as, for example, printed publication 103 shown and described herein with respect to FIG. 1A. At method block 201, a first image of a portion of a printed publication is received from a first communications device associated with a user. In some embodiments, the first image may be similar to image 102 shown in FIG. 1A, and the communications device associated with the user may be similar to communications device 101 shown in FIGS. 1A and 1B. The first image may include an identifier uniquely associated with the user. In some embodiments, the identifier may be similar to identifier 111 shown and described with respect to FIG. 1A. At method block 202, the first image may be analyzed to verify the printed publication and to confirm that the identifier is associated with the user. In some embodiments, analyzing an image to verify a printed publication and to confirm that an identifier in the image is associated with a user may be similar to the analysis, verification, and confirmation functionalities described herein with respect to FIG. 1A.

FIG. 2B shows an example method 203 for authorizing digital content for viewing and/or downloading to a user's communications device. In some embodiments, the digital content of method 203 may be similar to the digital content described herein with respect to FIG. 1A. At method block 204, digital content associated with the identified printed publication (block 202) may be authorized for viewing on and/or downloading to the first communications device (block 201) and/or one or more additional communications devices in response to verifying that the identifier is associated with the user (block 202). At method block 205, a record of the authorization may be stored in a database configured to be accessible for future confirmation of the authorization. In some embodiments, storing a record of the authorization may be similar to the storing of a record of authorization described herein with respect to FIG. 1A.

FIG. 2C shows an example method 206 for re-verifying a user's ownership of a printed publication. At method block 207, a second image corresponding to an additional portion of the printed publication is requested from a user. The second image may also include the user's identifier. The second image may be received at method block 208 in response to the request (block 207). At method block 209, the second image may be analyzed to verify the printed publication and to confirm that the second image includes the user's associated identifier.

FIG. 2D shows an example method 210 for generating an offer associated with a publication. At method block 211, an offer for at least one discounted product or service associated with the identified publication (block 202) may be generated. Then, at block 212, the generated offer may be sent to the first communications device (block 201). In some embodiments, generating an offer for discounted products and/or services associated with a printed publication may be similar to the generation of offers for discounted products and/or services described herein with respect to FIG. 1A.

FIG. 2E shows an example method 213 for sending authorized digital content to a user's communications device. At method block 214, a request for digital content is received from a user's communications device. At method block 215, a determination is made as to whether the requested digital content has been previously authorized for viewing and/or downloading to a user's communications device. In response to determining that the requested content has been previously authorized for viewing and/or downloading, at method block 216, the transmission of the requested content to the user's communications device may be initiated. In some embodiments, initiating the transmission of the digital content may be performed by an authentication server similar to the authentication server 104 shown and described with respect to FIGS. 1A and 1B. In other embodiments, the transmission of the digital content may be initiated by a content server such as, for example, content server 107 shown in FIGS. 1A and 1B. In still other embodiments, the initiation of the transmission of the content may be performed via cooperation between multiple servers, such as, for example, the authentication server 104 and content server 107 shown in FIGS. 1A and 1B.

FIG. 2F shows an example method 217 for crowd-sourcing images associated with publications. At method block 218, an image may be received from a user's communications device may be stored in a database, and at method block 219, the image may be associated with a publication. In some embodiments, one or more of the functions of example method 217 may be executed by one or more servers, such as, for example, the authentication server 104, the crowd-sourcing server 113, or the content server 107 shown and described with respect to FIG. 1A.

4. Methods for Implementation with Client Communications Devices

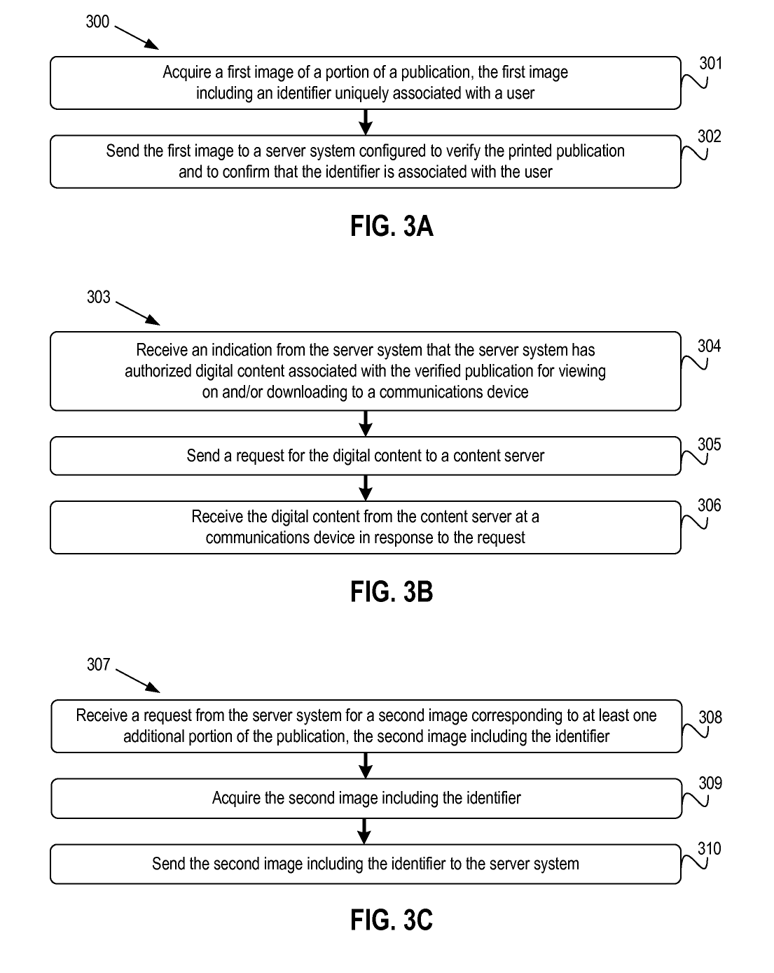

FIGS. 3A-C show example methods that may be performed by a client communications device according to some embodiments of the disclosed systems and methods. In some embodiments, one or more of the features and functions shown and described with respect to FIGS. 3A-C may be executed and/or implemented by a communications device such as, for example, communications device 101 shown and described with respect to FIG. 1A. However, some features and/or functions of the methods shown and described with respect to FIGS. 3A-C may be executed and/or performed by communications devices different than the communications device 101 shown and described with respect to FIGS. 1A and 1B. Although the methods of FIGS. 3A-C are primarily described with respect to communications device 101, in some embodiments, certain aspects of the methods of FIGS. 3A-C may also be performed by kiosk 114 shown and described with respect to FIG. 1A.

FIG. 3A shows an example method 300 for acquiring and sending an image to a server system for analysis. At method block 301, a first image of a portion of a publication is acquired by a client communications device, such as, for example, communications device 101 shown and described with respect to FIGS. 1A and 1B. The client communications device may acquire the first image by taking a digital photograph of the portion of the printed publication with an integrated digital camera, by obtaining the image of the portion of the printed publication from an external digital camera, or by receiving the image via an email, text message, or other communications message, or by acquiring the image via any other way that a communications device might acquire a digital file. The first image may include an identifier that is uniquely associated with a user. In some embodiments, the first image including the portion of the publication and the user identifier may be similar to image 102 that includes the portion 110 of the publication 103 and the identifier 111, as shown and described herein with respect to FIG. 1A.

At method block 302, the first image may be sent to a server system configured to verify the printed publication and to confirm that the identifier is associated with the user that sent the image for analysis. In some embodiments, the server system may be similar to the authentication server 104 shown and described herein with respect to FIGS. 1A and 1B.

FIG. 3B shows an example method 303 for receiving digital content associated with a printed publication at a client communications device. At method block 304, an indication may be received from a server system. In some embodiments, the server system may be similar to the server systems described herein with respect to FIGS. 1A and 1B, such as, for example, authentication server 104 and/or content server 107. The indication may confirm that the server system has authorized digital content associated with the identified publication (block 302) for viewing and/or downloading to the client communications device. In some embodiments, the indication and digital content may be similar to indications and digital content described herein with respect to FIG. 1A.

At method block 305, a request for the digital content may be sent to a content server. Then, in response to the request for the digital content, at method block 306, the requested digital content may be received at the client communications device. In some embodiments, the content server may be similar to the content server 107 shown and described herein with respect to FIGS. 1A and 1B.

FIG. 3C shows an example method 307 for either or both of (i) re-verifying a user's ownership of a printed publication or (ii) crowd-sourcing images for association with printed publications. At method block 308, a request is received from a server system. The server system may be similar to the server systems shown and described herein with respect to FIGS. 1A and 1B, such as, for example, authentication server 104, content server 107, and/or crowd-sourcing server 113.

The request may be a request for a second image corresponding to at least one additional portion of the publication. At method block 309, the requested image may be acquired by the client communications device. The image may include the additional portion of the publication and the user's associated identifier. After acquiring the second image (block 309), the second image including the user's identifier may be sent to the server system where it may be (i) analyzed to verify the publication and confirm that identifier is associated with user for the case where the image is being used for re-verifying a user's ownership or (ii) associated with a publication for the case where the image is being used for crowd-sourcing images for association with printed publications.

5. Other Example Methods

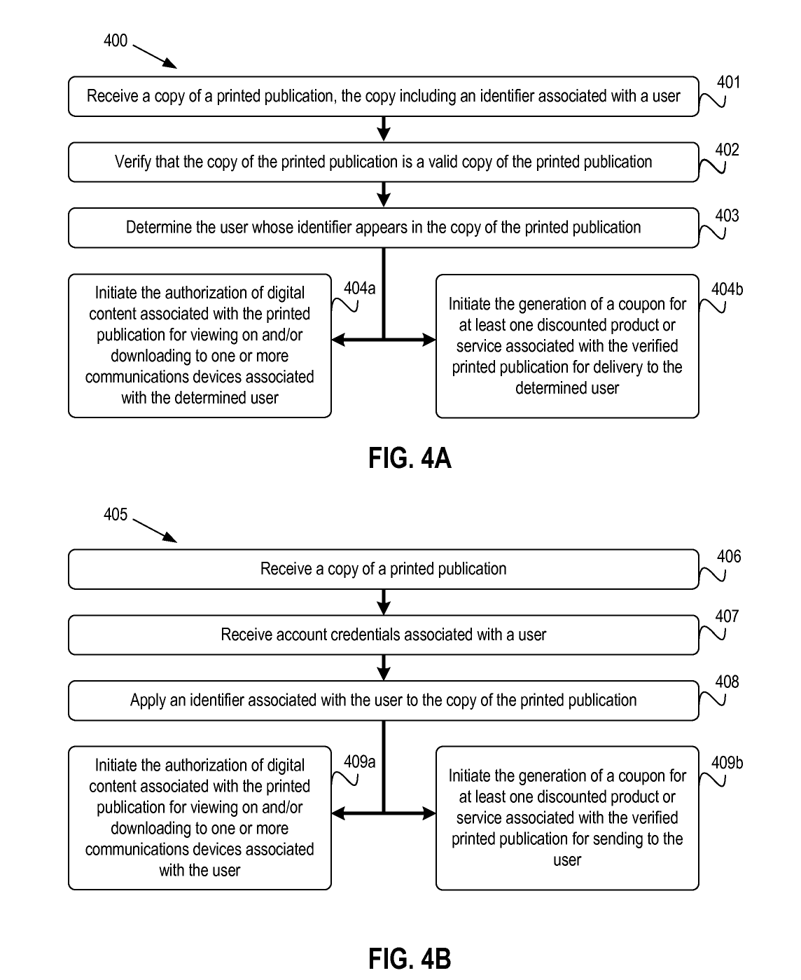

FIGS. 4A and 4B show example methods 400 and 405 that may be performed by humans, computer-based kiosks (or similar devices), and/or combinations thereof according to some embodiments.

FIG. 4A shows method 400 that may be performed by a human, a kiosk (such as kiosk 114 for example), and/or a combination thereof. At method block 401, a copy of a printed publication is received by the human or the kiosk. The copy of the printed publication may include an identifier associated with a user. The identifier may be similar to identifier 111 shown and described with respect to FIG. 1A. At method block 402, a verification may be made as to whether the provided copy of the printed publication is a valid copy (i.e., not an unauthorized reproduction) of the printed publication. A human may verify that the copy is a valid copy by physically inspecting the copy. A kiosk may employ sensor technology (e.g., imaging sensors, height/width/length sensors, weight sensors, etc.) to determine whether the received copy is a bound copy (such as a book or magazine) or a photocopied excerpt from the publication.

At method block 403, the user whose identifier appears in the copy of the printed publication may be determined. In some embodiments, a human may look up the identifier in a database of identifiers to determine the user. In other embodiments, the human may use an optical reader configured to read the identifier from the printed publication, or a human may acquire an image (e.g., a scan, a photograph, or other image) of at least a portion of the printed publication that includes the identifier. In still other embodiments, a kiosk may be configured to: (i) read the identifier from the printed publication with an optical reader device; and/or (ii) acquire an image (e.g., a scan, a photograph, or another image) of at least a portion of the printed publication containing the identifier, and then send the image to an authentication server in a manner similar to that shown in FIG. 1A and described with respect to communications device 101 and authentication server 104.

After determining the user associated with the identifier appearing in the copy of the printed publication, method 400 may proceed to one (or both) of method blocks 404a and/or 404b. At method block 404a, digital content associated with the printed publication may be authorized (or at least the authorization is initiated) for viewing on and/or downloading to one or more communications devices associated with the determined user. Additionally or alternatively, at method block 404b, at least one coupon for at least one discounted product and/or service may generated (or at least the generation is initiated) for delivery to the determined user.

FIG. 4B shows another method 405 that may be performed by a human, a kiosk (such as kiosk 114, for example), and/or any combination thereof. At method block 406, a copy of the printed publication may be received. In some embodiments, the copy of the printed publication may not already include an identifier associated with a user. In other embodiments, however, the copy of the printed publication may already include an identifier associated with a user.

At method block 407, account credentials associated with a user may be received. In some embodiments, a human may receive the account credentials from a user. In other embodiments, a kiosk may receive the account credentials from a user. The account credentials may be provided according to any of the mechanisms disclosed and described with respect to FIG. 1A herein. In some embodiments, an identifier associated with the user corresponding to the provided account credentials may be applied to the provided copy of the printed publication at method block 408. For example, after a person provides user account credentials and a copy of a printed publication to a kiosk (or human), the kiosk (or a human) may, in some embodiments apply an identifier associated with the user corresponding to the provided account credentials to the provided copy of the printed publication. The identifier may be similar to identifier 111 shown and described with respect to FIG. 1A. However, applying the identifier at method block 408 may not be required in all embodiments. Next, method 405 may proceed to one (or both) of method blocks 409a and/or 409b. At method block 409a, digital content associated with the printed publication may be authorized (or at least the authorization is initiated) for viewing on and/or downloading to one or more communications devices associated with the determined user. Additionally or alternatively, at method block 409b, at least one coupon for at least one discounted product and/or service may generated (or at least the generation is initiated) for delivery to the determined user.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
receiving a first image of a portion of a printed publication from a first communications device associated with a user, the first image including an identifier uniquely associated with the user; and
analyzing the first image to verify the printed publication and to confirm that the identifier is associated with the user.

2. The method of claim 1, further comprising:
authorizing digital content associated with the verified printed publication for viewing on and/or downloading to the first communications device and/or one or more additional communications devices in response to confirming that the identifier is associated with the user.

3. The method of claim 2, further comprising:
storing a record of the authorization in a database system configured to be accessible for future confirmation that the digital content has been authorized for viewing and/or download.

4. The method of claim 2, further comprising:
requesting a second image for analysis, the second image corresponding to at least one additional portion of the printed publication and including the identifier;
receiving the second image in response to the request; and
analyzing the second image to verify the printed publication and to confirm that the second image includes the identifier associated with the user.

5. The method of claim 1, further comprising:
generating an offer for at least one discounted product or service associated with the verified printed publication.

6. The method of claim 1, wherein analyzing the first image comprises determining whether the portion of the printed publication shown in the first image corresponds to a predefined portion of the printed publication.

7. The method of claim 1, wherein the first image is a digital photograph of the portion of the printed publication.

8. The method of claim 1, wherein the identifier is one or more alpha-numeric letters and/or images.

9. The method of claim 1, wherein the identifier includes one or more of a stamp, a signature, and an identification number.

10. The method of claim 1, wherein the identifier at least partially overlies at least a portion of text, graphics, or other symbols included within the portion of the printed publication.

11. The method of claim 1, wherein the digital content is at least one of an electronic copy of the printed publication or multimedia content associated with the printed publication.

12. The method of claim 1, further comprising:
storing the first image in a database; and
associating the first image with the printed publication.

13. A system comprising:
communications circuitry configured to receive a first image of a portion of a printed publication from a first communications device associated with a user, the first image including an identifier uniquely associated with the user; and
one or more processors configured to analyze the first image to verify the printed publication and to confirm that the identifier is associated with the user.

14. The system of claim 13, wherein the one or more processors are further configured to authorize digital content associated with the verified printed publication for viewing on and/or downloading to the first communications device and/or one or more additional communications devices associated with the user in response to confirming that the identifier is associated with the user.

15. The system of claim 14, further comprising computer readable storage media, wherein the one or more processors are configured to generate a record of the authorization and store the record of the authorization in the computer readable storage media, and wherein the computer readable storage media is configured to be accessible for future confirmation that the digital content has been authorized for viewing and/or download.

16. The system of claim 13, wherein the one or more processors are configured to send a request for a second image, wherein the second image corresponds to at least one additional portion of the printed publication and includes the identifier, and wherein the one or more processors are configured to analyze the second image to verify the printed publication and to confirm that the second image includes the identifier associated with the user.

17. The system of claim 13, wherein the one or more processors are configured to send a notification corresponding to an offer for at least one discounted product or service associated with the identified printed publication.

18. The system of claim 13, wherein the identifier is one or more alpha-numeric letters and/or images.

19. The system of claim 13, wherein the identifier includes one or more of a stamp, a signature, and identification number.

20. The system of claim 13, wherein the digital content is one of an electronic copy of the printed publication or multimedia content associated with the printed publication.

21. The system of claim 13, further comprising a database configured to store the first image, wherein the first image is associated with the printed publication in the database.

22. An article of manufacture including computer readable media with instructions encoded thereon, the instructions comprising:
instructions for receiving a first image of a portion of a printed publication from a first communications device associated with a user, the first image including an identifier uniquely associated with the user; and
instructions for analyzing the first image to verify the printed publication and to confirm that the identifier is associated with the user.

23. The article of manufacture of claim 22, wherein the instructions further comprise instructions for authorizing digital content associated with the identified printed publication for viewing on and/or downloading to the first communications device and/or one or more additional communications devices associated with the user in response to confirming that the identifier is associated with the user.

24. The article of manufacture of claim 22, wherein the instructions further comprise:
instructions for generating a record of the authorization; and
instructions for storing a record of the authorization in a database system configured to be accessible for future confirmation that the digital content has been authorized for viewing and/or download.

25. The article of manufacture of claim 22, wherein the instructions further comprise instructions for generating an offer for at least one discounted product or service associated with the identified printed publication.

26. A method comprising:
acquiring a first image of a portion of a printed publication, the first image including an identifier uniquely associated with a user; and
sending the first image to a server system configured to verify the printed publication and to confirm that the identifier is associated with the user.

27. The method of claim 26, further comprising:
receiving an indication from the server system that the server system has authorized digital content associated with the verified printed publication for viewing on and/or downloading to a communications device.

28. The method of claim 27, wherein the indication is any of a key, a password, a link, or a token for use in viewing and/or downloading the digital content to a communications device.

29. The method of claim 27, further comprising:
sending a request for the digital content to a content server; and
receiving the digital content from the content server at a communications device.

30. The method of claim 26, further comprising:
receiving a request from the server system for a second image corresponding to at least one additional portion of the printed publication;
acquiring the second image, wherein the second image includes both the requested one additional portion of the printed publication and the identifier associated with the user; and
sending the second image including the identifier to the server system.

31. The method of claim 26, further comprising receiving an offer for at least one discounted product or service associated with the printed publication.

32. The method of claim 26, wherein the first image of the portion of the printed publication is a predefined portion of the printed publication.

33. The method of claim 26, wherein the image is a digital photograph of the portion of the printed publication.

34. The method of claim 26, wherein the identifier is one or more alpha-numeric letters and/or images.

35. The method of claim 26, wherein the identifier includes one or more of a stamp, a signature, and an identification number.

36. The method of claim 26, wherein the identifier at least partially overlies at least a portion of text, graphics, or other symbols included within the portion of the printed publication.

37. The method of claim 26, wherein the digital content is one of an electronic copy of the printed publication or multimedia content associated with the printed publication.

38. A system comprising:
a camera for acquiring a first image of a portion of a printed publication, the first image including an identifier uniquely associated with a user; and
communications circuitry configured to send the first image to a server system, wherein the server system is configured to verify the printed publication and to confirm that the identifier is associated with the user.

39. The system of claim 38, wherein the communications circuitry is further configured to receive an indication from the server system that the server system has authorized digital content associated with the verified printed publication for viewing on and/or downloading to a communications device.

40. The system of claim 39, wherein the indication is any of a key, a password, a link, or a token for use in viewing and/or downloading the digital content to a communications device.

41. The system of claim 38, wherein the communications circuitry is further configured to receive an offer for at least one discounted product or service associated with the printed publication.

42. The system of claim 38, wherein the first image of the portion of the printed publication is a predefined portion of the printed publication.

43. The system of claim 38, wherein the identifier is one or more alpha-numeric letters and/or images.

44. The system of claim 38, wherein the identifier includes at least one of a stamp, a signature, and identification number.

45. The system of claim 38, wherein the digital content is at least one of an electronic copy of the printed publication or multimedia content associated with the printed publication.

46. An article of manufacture including computer readable media with instructions encoded thereon, the instructions comprising:
instructions for acquiring a first image of a portion of a printed publication, the first image including an identifier uniquely associated with a user; and
instructions for sending the first image to a server system configured to verify the printed publication and to confirm that the identifier is associated with the user.

47. The article of manufacture of claim 46, wherein the instructions further comprise:
instructions for receiving an indication from the server system that the server system has authorized digital content associated with the verified printed publication for viewing on and/or downloading to a communications device.

48. The article of manufacture of claim 46, wherein the instructions further comprise:
instructions for sending a request for the digital content to the server system; and
instructions for receiving the digital content at a communications device.

49. A method comprising:
receiving a copy of a printed publication;
verifying that the copy of the printed publication is a valid copy of the printed publication; and
in response to verifying that the copy of the printed publication is a valid copy of the printed publication, initiating at least one of (i) authorizing digital content associated with the printed publication for viewing on and/or downloading to one or more communications devices associated with a user, and/or (ii) generating a coupon for at least one discounted product or service associated with the verified printed publication.

50. The method of claim 49, wherein the copy of the printed publication includes an identifier associated with a user, and wherein the method further comprises determining the user associated with the identifier included in the copy of the printed publication.

51. The method of claim 49, further comprising:
receiving login credentials associated with the user; and
applying an identifier associated with the user to at least a portion of the printed publication.

52. The method of claim 49, further comprising, generating an image of at least a portion of the copy of the printed publication.
